(19) United States
(12) Patent Application Publication
(10) Pub. No.: US 2011/0316848 A1
(43) Pub. Date: Dec. 29, 2011

(54) CONTROLLING OF DISPLAY PARAMETER SETTINGS

(75) Inventors: Philip S. Newton, Eindhoven (NL); Francesco Scalori, Capolago (CH); Wiebe De Haan, Eindhoven (NL); Gerardus Wilhelmus Theodorus Van Der Heijden, Eindhoven (NL); Dennis Daniel Robert Jozef Bolio, Eindhoven (NL); Harry F.P. Van Doveren, Eindhoven (NL)

(73) Assignee: KONINKLIJKE PHILIPS ELECTRONICS N.V., EINDHOVEN (NL)

(21) Appl. No.: 13/140,148

(22) PCT Filed: Dec. 8, 2009
(86) PCT No.: PCT/IB2009/055583

§ 371 Date: Jun. 16, 2011

(30) Foreign Application Priority Data
Dec. 19, 2008 (EP) 08172347.0

(51) Int. Cl. G06T 15/00; G09G 5/00

(52) U.S. Cl. 345/419; 345/581

(57) ABSTRACT

A system of controlling displaying of image data has a source device (10), for example a BD player, which processes source image data for outputting the image data in dependence of first display parameters, and has a user control (15) for controlling the display parameters. The image data is transferred from the source device to a display device (13), which displays the image data in dependence of further display parameters, and has a further user control (16) for setting the further display parameters. The source device provides a display control mask structure, which is transferred with the image data to the display device. The display device displays the image data in dependence of the display control mask structure by masking said setting of the further display parameters according to the display control mask structure. Advantageously in a 3D system the depth settings of the display device are controlled based on the display control mask structure based on data from the content author

### FIELD OF THE INVENTION

The invention relates to a method of controlling displaying of image data, the method comprising at a source device, processing source image data for outputting the image data in dependence of first display parameters, the source device being provided with first user control elements for controlling the first display parameters, transferring the image data from the source device to a display device, and, at the display device, receiving the image data and displaying the image data in dependence of second display parameters, the display device being provided with second user control elements for setting the second display parameters.

The invention further relates to a device for controlling displaying of image data, a display device for displaying image data, a signal and computer program product for controlling displaying of image data.

The invention relates to the field of rendering and displaying image data, e.g. video, on a display device and controlling display parameter settings by a user.

### BACKGROUND OF THE INVENTION

Devices for rendering video data are well known, for example video players like DVD players or set top boxes for rendering digital video signals. The document U.S. Pat. No. 5,923,627 describes an example of such a rendering device. The rendering device is commonly used as a source device to be coupled to a display device like a TV set. Image data is transferred from the source device via a suitable interface like HDMI. The user of the video player is provided with a set of user control elements like buttons on a remote control device or virtual buttons and other user controls in a graphical user interface (GUI). The user control elements allow the user to adjust the rendering of the image data in the video player.

Furthermore, the display device will provide further user control elements for adjusting the display functions, e.g. setting contrast and color on the display screen.

### SUMMARY OF THE INVENTION

The document U.S. Pat. No. 5,923,627 provides an example of a rendering device where the user may adjust the rendering via the user control elements. However, as the display device provides further user control elements, various functions may be set at different points in the rendering system constituted by the set of coupled devices. Moreover, the author of the image data, e.g. a movie director, may want to control the rendering of the image data at the actual display for the viewer. Hence the known system has the problem that the control of display parameters is provided at various points in the rendering system.

It is an object of the invention to provide a more consistent control of the display parameters that are used at the display device.

For this purpose, according to a first aspect of the invention, in the method as described in the opening paragraph, comprises, at the source device, providing a display control mask structure, transferring the display control mask structure with the image data from the source device to the display device, and, at the display device, receiving the display control mask structure and displaying the image data in dependence of the display control mask structure by masking said setting of the second display parameters according to the display control mask structure.

For this purpose, according to a second aspect of the invention, the device for controlling displaying of image data as described in the opening paragraph comprises output means for transferring the image data from the source device to a display device, first user control elements for controlling first display parameters, processing means for processing source image data for providing the image data to the output means in dependence of the first display parameters, control mask means for providing a display control mask structure, and the output means are arranged for transferring the display control mask structure with the image data from the device to the display device.

For this purpose, according to a further aspect of the invention, the display device comprises input means for receiving the image data transferred from a source device, second user control elements for setting second display parameters, display means for displaying the image data in dependence of the second display parameters, and masking means for masking said setting of the second display parameters according to a display control mask structure, wherein the input means are arranged for receiving the display control mask structure with the image data, and the display means are arranged for displaying the image data in dependence of the display control mask structure.

For this purpose, according to a further aspect of the invention, the signal for controlling displaying of image data in a display device is representing the image data, and comprises a display control mask structure for, at the display device, displaying the image data in dependence of the display control mask structure by masking said setting of the display parameters according to the display control mask structure.

For this purpose, according to a further aspect of the invention, in the computer program product for controlling displaying of image data, the program is operative to cause a processor to perform, at the source device and/or the display device, the respective steps of the method mentioned above.

The measures have the effect that the display parameters which are used for displaying the image data for the viewer are set as controlled by the display control mask structure. In particular the function of the second user control elements for setting the display parameters at the display device is masked according to the display control mask structure. Advantageously the display device now constitutes a controlled part of the rendering system with respect to setting the display parameters. The control is executed by transferring the display control mask structure from the source device to the display device, which advantageously allows the source device to implement any control function or restriction as indicated by the source of the image data, e.g. retrieved from a record carrier that contains both the image data and masking information.

The invention is also based on the following recognition. The setting of display parameters is performed in an image rendering system, which is constituted by a chain of linked devices that subsequently process the image data. The current state of the art image rendering systems allow the user to modify display parameters at multiple stages in said chain. In particular, the user might inadvertently change a display parameter that affects an image parameter which has purposely set to a specific value earlier in the chain, e.g. by the author of a movie. For example the author may have designed the image to be very colorful, whereas the user reduces the color at the display device. The inventors have seen that the setting at the display device should be made controllable when appropriate, i.e. in a dynamic way in relation to the image data that is rendered. Generating the display control mask structure at the source device and transferring the display control mask structure with the image data to the display device achieves such control. When conditions change a new instance of the mask can be generated and transferred. This has the advantage that the source device is enabled to control, limit and/or restrict the operation of the user control elements at the display device in dependence on the image data.

It may be noted that U.S. Pat. No. 5,923,627 describes to provide a mask that limits user operation of special reproduction functions in an optical disc playback device, e.g. does not permit a fast forward scan function. The optical disk may include control information that includes a mask flag indicating whether to mask a key interrupt requesting the special reproduction mode. It is to be noted that such control does only affect the operation of the disc playback device itself, i.e. by blocking some of the user playback control functions during playback of the record carrier. Hence the mask is applied to the operation of the playback device in the process of retrieving the image data itself. The document does not relate to display parameter settings at all. Moreover, the document is silent on any control functions that might be executed on different locations in a chain of image processing devices, i.e. not in the playback device itself.

In an embodiment of the rendering system the image data comprises depth information for displaying on a 3D display device, the second display parameters comprise display depth parameters, and the display control mask structure comprises depth masking control data for masking at least one depth parameter setting. The effect is that various elements are displayed at specific depth display positions under the control of the display control mask structure. Setting depth parameters has been considered previously to be just another display setting, which, in prior art devices, could be controlled by the user at the display device. However, the inventors have seen that some image data must be rendered under careful control of the depth parameter settings for avoiding confusion at the user, or even disturbing or nauseating effects due to distorted depth display rendering. Starting from such recognition the inventors provided a solution in that the display control mask structure is transferred with the image data to the display device to control the setting of depth parameters, while the control mask comprising the depth masking control data is generated at the source device. This has the advantage that the source device is enabled to control, limit and/or restrict the depth range at the display device in accordance with the image data to achieve an effective and correct use of the depth range of the display device.

In an embodiment of the device the processing means are arranged for retrieving the source image data and related mask data from an information carrier, and the control mask means are arranged for providing the display control mask structure in dependence of the mask data. The effect is that the display control mask structure is generated based on the mask data retrieved from the information carrier, whereas the generated display control mask structure is subsequently transferred to the display device. Hence the author of the image data on the information carrier is now enabled to control the setting of display parameters at the display device.

Further preferred embodiments of the device and method according to the invention are given in the appended claims, disclosure of which is incorporated herein by reference.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows a system for rendering image data,

FIG. 2 shows an example of image data,

FIG. 3 shows an image data structure,

FIG. 4 shows a section of a User Operation mask table,

FIG. 5 shows a display control mask structure comprising depth masking control data,

FIG. 6 shows a packet type for carrying depth settings, and

FIG. 7 shows a HDMI Data Island Packet carrying parallax settings. In the Figures, elements which correspond to elements already described have the same reference numerals.

### DETAILED DESCRIPTION OF EMBODIMENTS

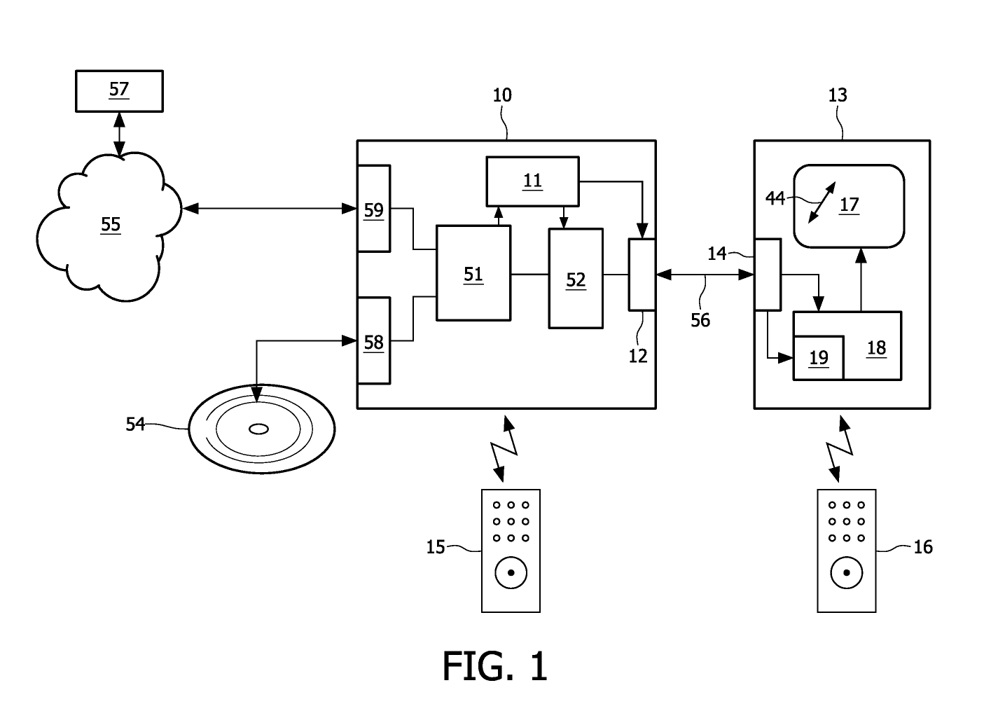

FIG. 1 shows a system for rendering image data, such as video, graphics or other visual information. A rendering device 10 is coupled as a source device to transfer data to a display device 13. The rendering device has an input unit 51 for receiving image information. For example the input unit device may include an optical disc unit 58 for retrieving various types of image information from an optical record carrier 54 like a DVD or BluRay disc. Alternatively, the input unit may include a network interface unit 59 for coupling to a network 55, for example the internet or a broadcast network. Image data may be retrieved from a remote media server 57.

The rendering device has a processing unit 52 coupled to the input unit 51 for processing the image information for generating transfer information 56 to be transferred via an output unit 12 to the display device. The processing unit 52 is arranged for generating the image data included in the transfer information 56 for display on the display device 13. The rendering device is provided with user control elements, now called first user control elements 15, for controlling display parameters of the image data, such as contrast or color parameter. The user control elements as such are well known, and may include a remote control unit having various buttons and/or cursor control functions to control the various functions of the rendering device, such as playback and recording functions, and for setting said display parameters, e.g. via a graphical user interface and/or menus. The processing unit 52 has circuits for processing the source image data for providing the image data to the output unit 12 in dependence of the display parameters as set by the user control elements.

The rendering device has a control mask unit 11 for providing a display control mask structure coupled to the output unit 12, which is further arranged for transferring the display control mask structure with the image data from the device to the display device as the transfer information 56. The display control mask structure is a set of control data that determines, limits and/or blocks/enables the operations that the user may perform when setting display parameters.

The display device 13 is for displaying image data. The device has an input unit 14 for receiving the transfer information 56 including image data transferred from a source device like the rendering device 10. The display device is provided with user control elements, now called second user control elements 16, for setting display parameters of the display, such as contrast or color parameters. The transferred image data is processed in processing unit 18 according to the display parameters and the setting commands from the user control elements. The device has a display 17 for displaying the processed image data, for example an LCD or plasma screen. Hence the display of image data is performed in dependence of the display parameters, which are set via the second user control elements.

The display device further includes a masking unit 19 coupled to the processing unit 18 for masking the user operation of said setting of the second display parameters according to a display control mask structure. The input unit 14 is arranged for receiving the display control mask structure with the image data. The display unit 17 is arranged for displaying the image data in dependence of the display control mask structure. For example the display control mask structure may instruct the masking unit to force the processing unit and display unit to block some of the user display setting functions like a color or contrast setting, or reset such parameters to default or predefined values.

FIG. 1 further shows the record carrier 54 as a carrier of the image data. The record carrier is disc-shaped and has a track and a central hole. The track, constituted by a series of physically detectable marks, is arranged in accordance with a spiral or concentric pattern of turns constituting substantially parallel tracks on an information layer. The record carrier may be optically readable, called an optical disc, e.g. a CD, DVD or BD (Blue-ray Disc). The information is represented on the information layer by the optically detectable marks along the track, e.g. pits and lands. The track structure also comprises position information, e.g. headers and addresses, for indication the location of units of information, usually called information blocks. The record carrier 54 carries information representing digitally encoded image data like video, for example encoded according to the MPEG2 encoding system, in a predefined recording format like the DVD or BD application format. For accommodating the control of the rendering of image data as proposed the marks in the track of the record carrier also embody the display control mask structure, or control data that allows generating the display control mask structure.

In case of BD systems, further details can be found in the publicly available technical white papers “Blu-ray Disc Format General August 2004” and “Blu-ray Disc 1. C Physical Format Specifications for BD-ROM November, 2005”, published by the Blu-Ray Disc association (http://www.bluraydisc.com).

In the following, when referring to the BD application format, we refer specifically to the application formats as disclosed in the US application No. 2006-0110111 (Attorney docket NL021359) and in white paper “Blu-ray Disc Format 2.B Audio Visual Application Format Specifications for BD-ROM, March 2005” as published by the Blu-ray Disc Association.

It is knows that BD systems also provide a fully programmable application environment with network connectivity thereby enabling the Content Provider to create interactive content. This mode is based on the Java™ platform and is known as “BD-J”. BD-J defines a subset of the Digital Video Broadcasting (DVB)-Multimedia Home Platform (MHP) Specification 1.0, publicly available as ETSI TS 101 812

In an embodiment the rendering system is arranged for displaying three dimensional (3D) image data on a 3D image display. Thereto the image data includes depth information for displaying on a 3D display device,

the second display parameters include display depth parameters, and
the display control mask structure includes depth masking control data for masking at least one depth parameter setting. Referring to the system described with reference to FIG. 1, the display device 53 now is a stereoscopic display, also called 3D display, having a display depth range indicated by arrow 44. The 3D image information may be retrieved from an optical record carrier 54 enhanced to contain 3D image data. Via the internet 3D image information may be retrieved from the remote media server 57.

The following section provides an overview of three-dimensional displays and perception of depth by humans. 3D displays differ from 2D displays in the sense that they can provide a more vivid perception of depth. This is achieved because they provide more depth cues then 2D displays which can only show monocular depth cues and cues based on motion.

Monocular (or static) depth cues can be obtained from a static image using a single eye. Painters often use monocular cues to create a sense of depth in their paintings. These cues include relative size, height relative to the horizon, occlusion, perspective, texture gradients, and lighting/shadows. Oculomotor cues are depth cues derived from tension in the muscles of a viewers eyes. The eyes have muscles for rotating the eyes as well as for stretching the eye lens. The stretching and relaxing of the eye lens is called accommodation and is done when focusing on a image. The amount of stretching or relaxing of the lens muscles provides a cue for how far or close an object is. Rotation of the eyes is done such that both eyes focus on the same object, which is called convergence. Finally motion parallax is the effect that objects close to a viewer appear to move faster then objects further away.

Binocular disparity is a depth cue which is derived from the fact that both our eyes see a slightly different image. Monocular depth cues can be and are used in any 2D visual display type. To re-create binocular disparity in a display requires that the display can segment the view for the left- and right eye such that each sees a slightly different image on the display. Displays that can re-create binocular disparity are special displays which we will refer to as 3D or stereoscopic displays. The 3D displays are able to display images along a depth dimension actually perceived by the human eyes, called a 3D display having display depth range in this document. Hence 3D displays provide a different view to the left- and right eye.

3D displays which can provide two different views have been around for a long time. Most of these were based on using glasses to separate the left- and right eye view. Now with the advancement of display technology new displays have entered the market which can provide a stereo view without using glasses. These displays are called auto-stereoscopic displays.

A first approach is based on LCD displays that allow the user to see stereo video without glasses. These are based on either of two techniques, the lenticular screen and the barrier displays. With the lenticular display, the LCD is covered by a sheet of lenticular lenses. These lenses diffract the light from the display such that the left- and right eye receive light from different pixels. This allows two different images one for the left- and one for the right eye view to be displayed.

An alternative to the lenticular screen is the Barrier display, which uses a parallax barrier behind the LCD and in front the backlight to separate the light from pixels in the LCD. The barrier is such that from a set position in front of the screen, the left eye sees different pixels then the right eye. A problem with the barrier display is loss in brightness and resolution but also a very narrow viewing angle. This makes it less attractive as a living room TV compared to the lenticular screen, which for example has 9 views and multiple viewing zones.

A further approach is still based on using shutter-glasses in combination with high-resolution beamers that can display frames at a high refresh rate (e.g. 120 Hz). The high refresh rate is required because with the shutter glasses method the left and right eye view are alternately displayed. For the viewer wearing the glasses perceives stereo video at 60 Hz. The shutter-glasses method allows for a high quality video and great level of depth.

The auto stereoscopic displays and the shutter glasses method do both suffer from accommodation-convergence mismatch. This does limit the amount of depth and the time that can be comfortable viewed using these devices. There are other display technologies, such as holographic- and volumetric displays, which do not suffer from this problem. It is noted that the current invention may be used for any type of 3D display that has a depth range.

Image data for the 3D displays is assumed to be available as electronic, usually digital, data. The current invention relates to such image data and manipulates the image data in the digital domain. The image data, when transferred from a source, may already contain 3D information, e.g. by using dual cameras, or a dedicated preprocessing system may be involved to (re-)create the 3D information from 2D images. Image data may be static like slides, or may include moving video like movies. Other image data, usually called graphical data, may be available as stored objects or generated on the fly as required by an application. For example user control information like menus, navigation items or text and help annotations may be added to other image data.

There are many different ways in which stereo images may be formatted, called a 3D image format. Some formats are based on using a 2D channel to also carry the stereo information. For example the left and right view can be interlaced or can be placed side by side and above and under. These methods sacrifice resolution to carry the stereo information. Another option is to sacrifice color, this approach is called anaglyphic stereo. Anaglyphic stereo uses spectral multiplexing which is based on displaying two separate, overlaid images in complementary colors. By using glasses with colored filters each eye only sees the image of the same color as of the filter in front of that eye. So for example the right eye only sees the red image and the left eye only the green image.

A different 3D format is based on two views using a 2D image and an additional depth image, a so called depth map, which conveys information about the depth of objects in the 2D image. The format called image+depth is different in that it is a combination of a 2D image with a so called “depth”, or disparity map. This is a gray scale image, whereby the gray scale value of a pixel indicates the amount of disparity (or depth in case of a depth map) for the corresponding pixel in the associated 2D image. The display device uses the disparity or depth map to calculate the additional views taking the 2D image as input. This may be done in a variety of ways, in the simplest form it is a matter of shifting pixels to the left or right dependent on the disparity value associated to those pixels. The paper entitled “Depth image based rendering, compression and transmission for a new approach on 3D TV” by Christoph Fen gives an excellent overview of the technology (see http://iphome.hhi.de/fehn/Publications/fehn_EI2004.pdf).

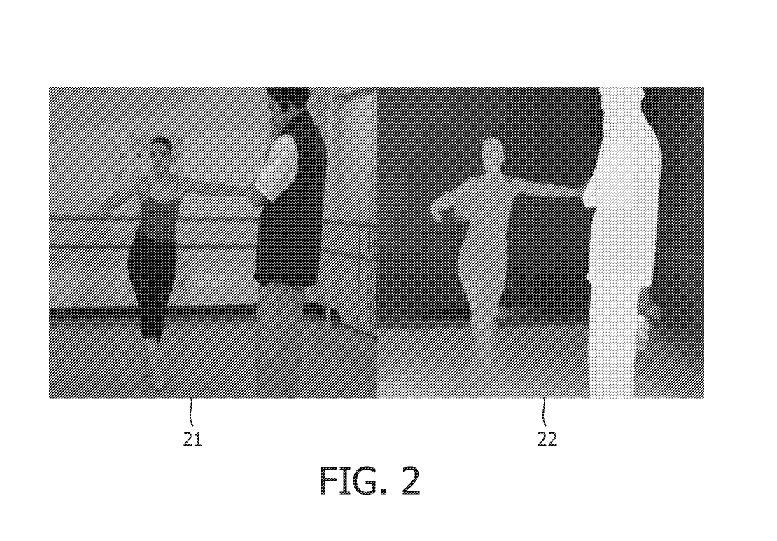

FIG. 2 shows an example of image data. The left part of the image data is a 2D image 21, usually in color, and the right part of the image data is a depth map 22. The 2D image information may be represented in any suitable image format. The depth map information may be an additional data stream having a depth value for each pixel, possibly at a reduced resolution compared to the 2D image. In the depth map grey scale values indicate the depth of the associated pixel in the 2D image. White indicates close to the viewer, and black indicates a large depth far from the viewer. A 3D display can calculate the additional view required for stereo by using the depth value from the depth map and by calculating required pixel transformations. Occlusions may be solved using estimation or hole filling techniques. Further maps may be added to the image and depth map format, like an occlusion map, a parallax map and/or a transparency map for transparent objects moving in front of a background.

Adding stereo to video also impacts the format of the video when it is sent from a player device, such as a Blu-ray disc player, to a stereo display. In the 2D case only a 2D video stream is sent (decoded picture data). With stereo video this increases as now a second stream must be sent containing the second view (for stereo) or a depth map. This could double the required bitrate on the electrical interface. A different approach is to sacrifice resolution and format the stream such that the second view or the depth map are interlaced or placed side by side with the 2D video. FIG. 2 shows an example of how this could be done for transmitting 2D data and a depth map. When overlaying graphics on video, further separate data streams may be used.

An example of a system for rendering 3D image information based on a combination of various image elements that applies the display control mask structure is arranged as follows. First the system receives image information, and secondary image information, to be rendered in combination with the image information. For example the various image elements may be received from a single source like an optical record carrier, via the internet, or from several sources (e.g. a video stream from a hard disk and locally generated 3D graphical objects, or a separate 3D enhancement stream via a network). The system processes the image information and the secondary image information for generating output information to be rendered in a three-dimensional space on a 3D display which has a display depth range. Assuming that the image information and the secondary information should not be intermingled in depth on the display, the rendering devices sets display depth ranges and/or depth offsets for the main image information and the secondary information, and generates the display control mask structure which controls corresponding depth control settings at the display device, e.g. in the display device blocking a change or setting of the depth offset for menu items of the secondary information. For such combined image data the author of the data may want to limit the setting of display parameters with respect to the depth. Thereto the proposed display control mask structure provides a suitable tool.

Content creators use 3D to create a more immersive experience than what can be provided in 2D, by means of the fact that objects can appear at various depth levels, more closely to what happens in reality. A lot of production and post-production time can be spent on tuning the exact depth values throughout a film.

Both the playback device and 3D display typically allow a user to change 3D-related settings by pressing a pair of buttons on the corresponding remote control. When a user changes depth parameters in the display the 3D experience is no longer the same as was intended by the content author. What is proposed here is a mechanism for the content creator that allows him to prevent the user from changing depth related settings in the display. Furthermore if the user does change the depth settings a mechanism is proposed such that the system can change back to the content creators intended depth settings.

The rendering system as proposed describes for each piece of content whether the user is allowed to change the depth settings or not. This is achieved through the use of a mask that tells, for each possible operation (i.e. every button on the remote), if that operation is allowed or not. When a playback device—typically a BD player—detects such a mask, it transmits the user operations mask to the display using commands sent over a video interface such as the well known HDMI interface (e.g. see “High Definition Multimedia Interface Specification Version 1.3a of Nov. 10 2006). This prevents the user from modifying the depth settings using either the player's or the display's remote control.

It is assumed that the playback device sends to the display a number of parameters describing what the effect should be to reflect what the content author intended. This allows that in a further embodiment the display overwrites the depth settings currently in use with the default ones, received from the playback device.

The main idea of the rendering system as described here represents a general solution to the problems stated in the above. The detailed description below is about the specific case of Blu-ray Disc playback and using the HDMI interface.

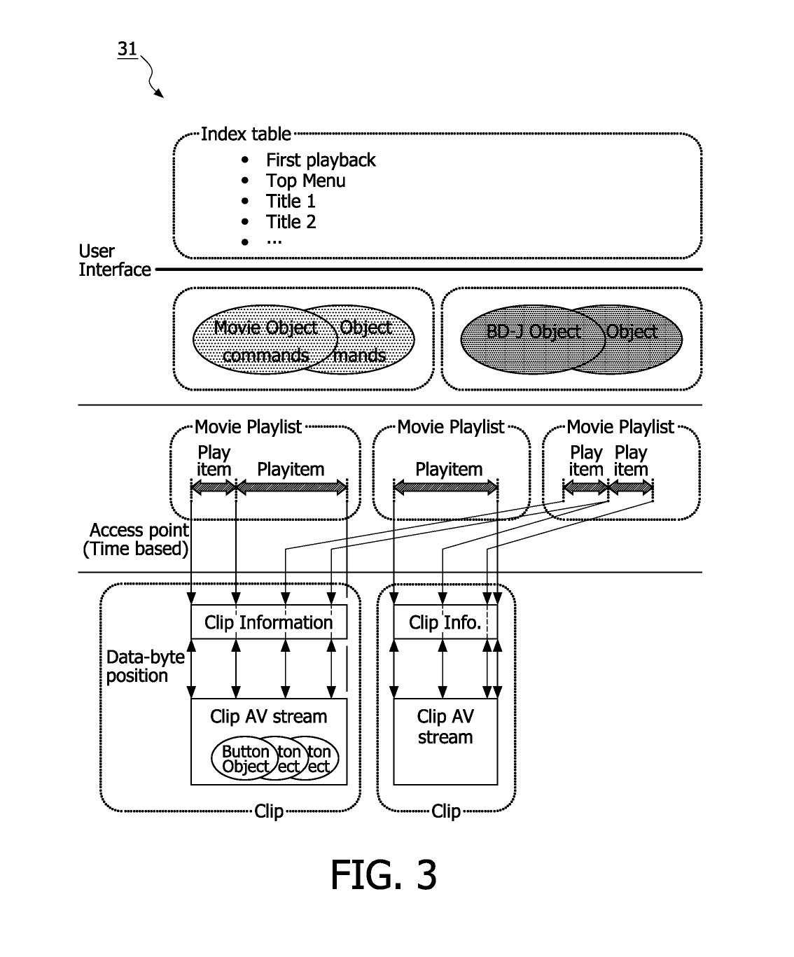

FIG. 3 shows an image data structure. The Figure shows a hierarchical image data structure 31 for storing audio video data (AV data) on a record carrier, e.g. an optical disc recording format like the Blu-ray disc, composed of Titles, Movie Objects, Play Lists, Play Items and Clips. The upper level shows the user interface based on an Index Table allowing to navigate between various titles and menus. A relevant item in the context of this description is the Play Item, which corresponds to a continuous portion of a video clip stored on the disc. The image data structure may be enhanced to include further control data to represent the display control mask structure as described below.

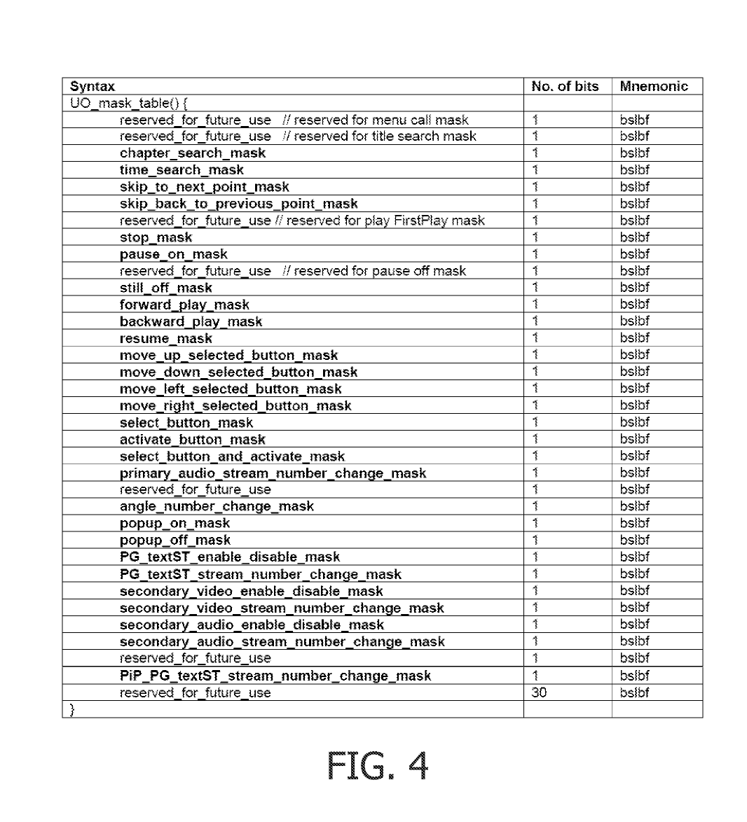

FIG. 4 shows a section of a User Operation mask table. The Figure shows an example of some of the metadata of a Play Item as shown in FIG. 3, specifically a section of the User Operation mask table, which lists interactions—skip, pause, play, etc.—that the user can have during viewing of a Play Item. The second column indicates, for each user operation, if it is enabled or not. It is to be noted that the existing structure of FIG. 4 only defines user operations that are related to data retrieval and navigation functions in the playback device.

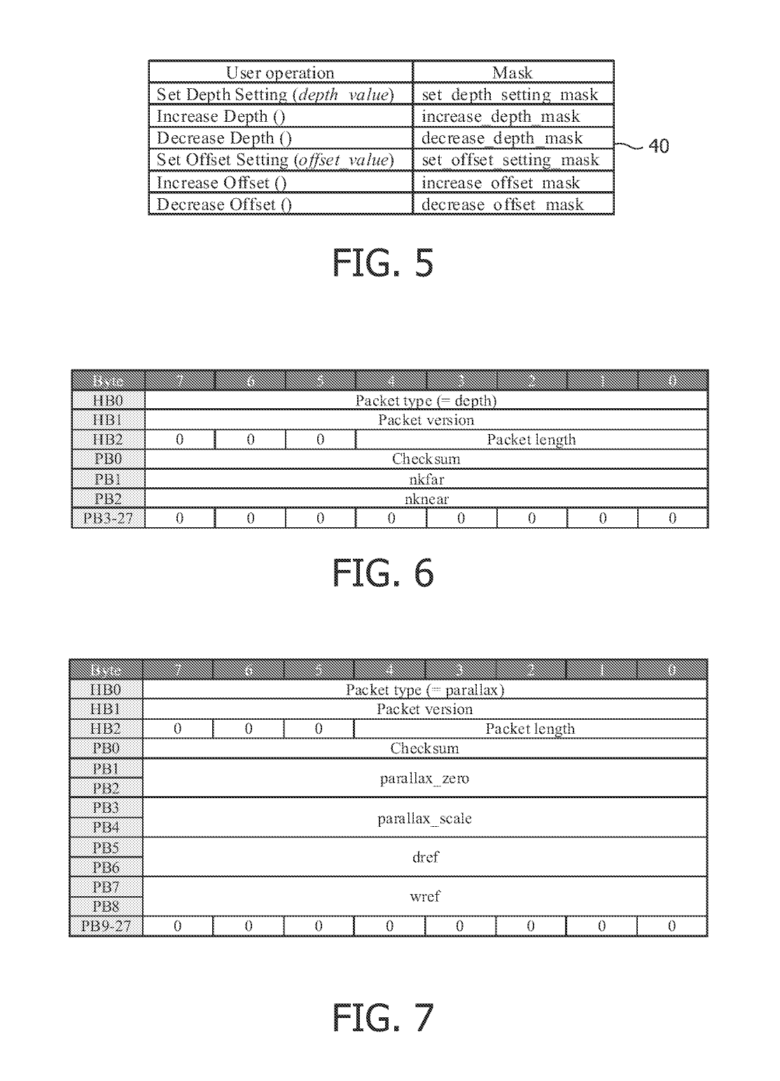

FIG. 5 shows a display control mask structure comprising depth masking control data. A display control mask structure 40 is shown having a column defining user display parameter settings and a second column defining masking values. Each row in the structure defines a user operation, and the mask filed defines an indicator or flag which indicates a mask to be applied, e.g allowing or blocking the user operation. The display control mask structure may be stored and transferred as a separate data entity or packet, or it may be combined with other control data. In a practical embodiment the data structure of FIG. 4 may be extended to include a number of new user operations and the corresponding masks according to the table shown in FIG. 5, using part of the bits previously marked “reserved for future use”.

Based on the display control mask structure comprising the depth masking control data flags of 1 bit, authors can, for each part of the content, enable (bit set to 0) or disable (bit set to 1) the listed operations. In general these operations could be enabled, but in certain scenes or parts they could be disabled, in order to guarantee the correct rendering of the content as intended by the content author. There might be even scenes (e.g. war scenes, scenes with a lot of camera movements) in which for instance the user operation Decrease Depth is allowed—in case the user starts feeling sick—while the user operation Increase Depth is forbidden.

The method above allows authors to decide which user operations are allowed, using the remote control of a Blu-ray player. In order to consistently have the same advantage on the display unit (usually the TV) and its respective user controls like the remote control, it is necessary that the playback device informs the TV about the user operation mask and that the TV is capable of understanding that message and changes its behaviour accordingly, allowing or disallowing certain operations from the user.

Various embodiments are possible. In a first embodiment the complete mask table (e.g. 64 bits) is sent, while in a second embodiment only the subset (e.g. 6 bits) representing the display control mask structure having the depth masking control data related to changing the depth settings.

For transferring the display control mask structure also various embodiments are possible. In a first embodiment the display control mask structure is inserted in the active picture; and frequently repeated, e.g. for every frame. For example this can be done in a similar way to known formats, i.e. by inserting the mask bits into a header at the top left corner of respective frames. The parameters are sent using the top-left corner of each frame. One option would be to use all the bits of the first pixels, but these “artificial” pixels could become visible. Alternatively only one bit in every pixel is used, for example the most significant bit of the blue component. To retrieve these parameters the display device needs to read a higher number of pixels but the visual experience is less affected.

In a further embodiment the display control mask structure is transferred asynchronously, e.g. as a separate packet in a data stream. The packet may include further data for frame accurately synchronizing with the video. For the second option, a new frame type has to be defined which carries the depth settings and is inserted at an appropriate time in the blanking intervals between successive video frames. In a practical embodiment the display control mask structure is inserted in packets within the HDMI Data Islands as described below.

The depth display parameters that are sent to the display to allow the display to correctly interpret the depth information. Examples of including additional information in video are described in the ISO standard 23002-3 “Representation of auxiliary video and supplemental information” (e.g. see ISO/IEC JTC1/SC29/WG11 N8259 of July 2007). Depending on the type of auxiliary stream the additional image data consists either of 4 or two parameters.

A further example of sending Auxiliary Video Information (AVI) including the display control mask structure in an audio video data (AV) stream is as follows. The AVI is carried in the AV-stream from the source device to a digital television (DTV) Monitor as an InfoFrame. If the source device supports the transmission of the Auxiliary Video Information (AVI) and if it determines that the DTV Monitor is capable of receiving that information, it shall send the AVI to the DTV Monitor once per VSYNC period. The data applies to the next full frame of video data.

Another embodiment enables the following scenario. While watching a film a user changes the depth settings to improve the experience, however at a certain moment a scene begins during which changing the depth settings is not allowed. The display device receives from the playback devices a number of parameters describing the depth settings as intended by the author. In this case the display, at the moment when the user operation to change the depth settings is disallowed, the depth settings currently being utilized are overwritten by the prescribed values received from the playback device.

For parallax based “3D” information the additional data consists of:

parallax_zero, that defines the value for which the amount of parallax is zero;

parallax_scale, which is a scaling factor that defines the dynamic range of the parallax values in the stream;

Wref, that defines the width of the reference display;

Dref that defines the reference distance of the viewer to the display

For depth based “3D” information the parameters are nknear and nkfar which describe the range of depth information relative to the width of the screen.

Besides these values the image data may also include other parameters such as for example an offset value that is used to shift the 3D space behind or in front of the display.

For transferring the image data and the display control mask structure the interface needs to be extended to carry these parameters, either in the active picture, repeated for every frame, or using packets of a newly defined type. The following example is based on the well known HDMI interface. In particular the display control mask structure may be transferred during the Data Island of HDMI as explained now. The Data Island periods can be used to send depth and offset related parameters.

FIG. 6 shows a packet type for carrying depth settings. In a first column header bytes (HB) and payload byes (PB) are listed, the rows further defining the respective function of the bytes. Known packet types include audio samples and clock regeneration packets. A new type can be introduced for depth related parameters and one for parallax related parameters. In the practical embodiment complying with HDMI Data Island Packets (e.g. see “High Definition Multimedia Interface Specification Version 1.3a of Nov. 10 2006), each packet has 27 bytes reserved for their payload and can be used to carry the actual values of the parameters

FIG. 7 shows a HDMI Data Island Packet carrying parallax settings. The meaning of the parameters listed in the parallax packet has been explained above. Various other depth display parameters can be included in the new packets as required.

It is to be noted that the invention may be implemented in hardware and/or software, using programmable components. A method for implementing the invention has the processing steps corresponding to the rendering system elucidated with reference to FIG. 1. A rendering computer program may have software function for the respective processing steps at the rendering device; a display computer program may have software function for the respective processing steps at the display device. Such programs may be implemented on a personal computer or on a dedicated video system. Although the invention has been mainly explained by embodiments using optical record carriers or the internet, the invention is also suitable for any image processing environment, like authoring software or broadcasting equipment. Further applications include a 3D personal computer [PC] user interface or 3D media center PC, a 3D mobile player and a 3D mobile phone.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software, and a processor may fulfill the function of one or more units, possibly in cooperation with hardware elements. Further, the invention is not limited to the embodiments, and lies in each and every novel feature or combination of features described above.

1. Method of controlling displaying of image data, the method comprising
at a source device, processing source image data for outputting the image data in dependence of first display parameters, the source device being provided with first user control elements for controlling the first display parameters,
transferring the image data from the source device to a display device,
at the display device, receiving the image data and displaying the image data in dependence of second display parameters, the display device being provided with second user control elements for setting the second display parameters,
characterized in that the method comprises
at the source device, providing a display control mask structure,
transferring the display control mask structure with the image data from the source device to the display device,
at the display device, receiving the display control mask structure and displaying the image data in dependence of the display control mask structure by masking said setting of the second display parameters according to the display control mask structure.

2. Method as claimed in claim 1, wherein the image data comprises depth information for displaying on a 3D display device,
the second display parameters comprise display depth parameters, and
the display control mask structure comprises depth masking control data for masking at least one depth parameter setting.

3. Method as claimed in claim 2, wherein the setting of the display depth parameters comprises at least one of
a depth setting, an increase depth setting, a decrease depth setting, an depth offset setting, an increase depth offset setting, a decrease depth offset setting,
and the depth masking control data is arranged for masking at least one of said depth parameter settings.

4. Method as claimed in claim 1, wherein transferring the display control mask structure comprises inserting the display control mask structure into a digital data stream transferring the image data according to a predefined interface standard.

5. Device for controlling displaying of image data, the device comprising
output means for transferring the image data from the source device to a display device,
first user control elements for controlling first display parameters, and
processing means for processing source image data for providing the image data to the output means in dependence of the first display parameters,
characterized in that the device comprises
control mask means for providing a display control mask structure, and
the output means are arranged for transferring the display control mask structure with the image data from the device to the display device.

6. Device as claimed in claim 5, wherein the first display parameters comprise display depth parameters for controlling displaying depth on a 3D display device, and
the display control mask structure comprises depth masking control data for masking at least one depth parameter setting on the 3D display device.

7. Device as claimed in claim 5, wherein the processing means are arranged for retrieving the source image data and related mask data from an information carrier, and the control mask means are arranged for providing the display control mask structure in dependence of the mask data.

8. Display device for displaying image data, the device comprising
input means for receiving the image data transferred from a source device,
second user control elements for setting second display parameters, and
display means for displaying the image data in dependence of the second display parameters,
characterized in that the device comprises
masking means for masking said setting of the second display parameters according to a display control mask structure, and wherein
the input means are arranged for receiving the display control mask structure with the image data, and
the display means are arranged for displaying the image data in dependence of the display control mask structure.

9. Signal for controlling displaying of image data in a display device,
the signal representing the image data, the display device being arranged for receiving the image data and displaying the image data in dependence of display parameters, the display device being provided with user control elements for setting the display parameters,
characterized in that the signal comprises
a display control mask structure for, at the display device, displaying the image data in dependence of the display control mask structure by masking said setting of the display parameters according to the display control mask structure.

10. Record carrier for controlling displaying of image data in a display device, the record carrier comprising a track constituted by physically detectable marks, the marks comprising the image data, the display device being arranged for receiving the image data and displaying the image data in dependence of display parameters, the display device being provided with user control elements for setting the display parameters,
characterized in that the marks further comprise
a display control mask structure for, at the display device, displaying the image data in dependence of the display control mask structure by masking said setting of the display parameters according to the display control mask structure.

11. Computer program product for controlling displaying of image data, which program is operative to cause a processor to perform, at the source device and/or the display device, the respective steps of the method as claimed in claim 1.
